(19) United States
(12) Patent Application Publication
(10) Pub. No.: US 2023/0152262 A1
(43) Pub. Date: May 18, 2023

(54) Dielectric Spectroscopic Measurement Device and Method

(71) Applicant: Nippon Telegraph and Telephone Corporation, Tokyo (JP)

(72) Inventors: Masahito Nakamura, Tokyo (JP); Michiko Seyama, Tokyo (JP)

(21) Appl. No.: 17/916,921

(22) PCT Filed: Apr. 6, 2020
(86) PCT No.: PCT/JP2020/015498

§ 371 Date: Oct. 4, 2022

(51) Int. Cl. G01N 27/02

(52) U.S. Cl. CPC G01N 27/026

(57) ABSTRACT

A dielectric spectroscopic measurement apparatus includes a first probe, a second probe, and a measurement instrument. The first probe includes a coaxial line and has opened one end as a detection end. The second probe includes a coaxial line and has opened one end as a detection end. Further, the second probe has a longer penetration length than the first probe. The measurement instrument determines a permittivity of a second medium from a result of a measurement of a measurement object using the first probe and a result of a measurement of the measurement object using the second probe.

### CROSS-REFERENCE TO RELATED APPLICATIONS

This patent application is a national phase filing under section 371 of PCT application no. PCT/JP2020/015498, filed on Apr. 6, 2020, which is incorporated herein by reference in its entirety.

### TECHNICAL FIELD

The present invention relates to a dielectric spectroscopic measurement apparatus and a method for measuring a complex permittivity of a slight amount of a liquid sample.

### BACKGROUND

With the progression of aging, it has been a big issue of concern how to address lifestyle diseases. A test for blood sugar level or the like, which requires blood drawing, is a larger burden on patients. Accordingly, a non-invasive component concentration measurement apparatus not requiring blood drawing has attracted attention.

For a non-invasive component concentration measurement, a technology using a microwave-millimeterwave-band electromagnetic wave has been proposed. This technology has advantages including less in vivo scatter and a lower energy per photon as compared with optical measurement using a near-infrared light. Examples using a microwave-millimeterwave-band electromagnetic wave include a measurement technology using a resonance structure as described in Non-Patent Literature 1. In this technology, a measurement device with a high Q value, such as an antenna or a resonator, is brought into contact with a measurement sample, thereby measuring frequency characteristics in the vicinity of a resonance frequency. The resonance frequency is determined by a complex permittivity around the measurement device and, accordingly, a correlation between a shift amount of the resonance frequency and a component concentration is predicted, thereby estimating the component concentration from the shift amount of the resonance frequency.

As another measurement technology using a microwave-millimeterwave-band electromagnetic wave, a dielectric spectroscopy method as described in Patent Literature 1 has been proposed. In the dielectric spectroscopy method, an electromagnetic wave is applied into skin and the electromagnetic wave is absorbed in accordance with an interaction between blood components as measurement targets, such as glucose molecules and water, thereby observing an amplitude and a phase of the electromagnetic wave. A dielectric relaxation spectrum is calculated from the observed amplitude and phase with respect to a frequency of the electromagnetic wave.

The dielectric relaxation spectrum is typically expressed as a linear combination of relaxation curves on the basis of a Cole-Cole expression, based on which a complex permittivity is calculated. For a measurement of a biological component, the amount of a blood component, such as glucose or cholesterol, contained in the blood is correlated with the complex permittivity, and an electrical signal (with amplitude, phase) corresponding to a change therein is measured. A quantitative detection model is created by measuring in advance a correlation between a change in the complex permittivity and a component concentration, and quantitative detection is performed for determining the component concentration by comparing a change in the measured dielectric relaxation spectrum and the quantitative detection model. Irrespective of whether either of the measurement technologies is used, an improvement in measurement sensitivity can be expected by selecting a frequency band that has a strong correlation with a target component. Accordingly, it is important to measure a change in permittivity in advance by broadband dielectric spectroscopy in advance.

Among dielectric spectroscopy methods, a technology using a coaxial probe (an open-ended coaxial probe or an open-ended coaxial line) as described in Non-Patent Literature 2 is capable of using an easily available sample such as water for calibration of a measurement instrument. Further, this measurement technology eliminates the necessity of special machining of a material and makes it possible to measure a permittivity of a measurement sample by bringing the sample to measure into contact with a probe end surface. In view of the above, the measurement technology using the coaxial probe described in Non-Patent Literature 2 is suitable for measuring a sample difficult to machine, such as a living body or soil.

### Citation List

### Patent Literature

Patent Literature 1: Japanese Patent Laid-Open No. 2013-032933.

### Non-Patent Literature

Non-Patent Literature 1: M. Hofmann et al., “Microwave-Based Noninvasive Concentration Measurements for Biomedical Applications”, IEEE Transactions on Microwave Theory and Techniques, vol. 61, no. 5, pp. 2195-2204, 2013.

Non-Patent Literature 2: J. P. Grant, “A critical study of the openended coaxial line sensor technique for RF and microwave complex permittivity measurements”, Journal of Physics E: Scientific Instruments, vol. 22, pp. 757-770, 1989.

### SUMMARY

### Technical Problem

However, a typical measurement using a coaxial probe, which is intended to accurately measure permittivity under conditions that a substance to measure has a sufficient thickness, is not capable of measuring permittivity in a case where a measurement target is thin unless a thickness of the measurement target is known. Further, in a case where a measurement target is multi-layered, a permittivity cannot be measured unless a permittivity or the like of a part of the measurement target is known.

For example, assuming a non-invasive biological component application such as analysis of a sugar content in a fruit or estimation of an in vivo glucose concentration, in many cases, a site where a coaxial probe is to be brought into contact is supposed to have a two-layer structure including at least a barrier layer for retaining water and an in vivo layer containing a lot of water. In such a case, it is desirable that an influence of the barrier layer be reduced so that a component concentration estimated from an in vivo permittivity and permittivity information can be calculated. However, it is difficult to measure an in vivo material permittivity and a thickness of the barrier layer in advance and, accordingly, a typical technology using a coaxial probe is not capable of an accurate measurement.

Embodiments of the present invention can solve a problem as described above and an object thereof is to enable a multilayer measurement target to be accurately measured by a dielectric spectroscopy method using a coaxial probe.

### Means for Solving the Problem

A dielectric spectroscopic measurement apparatus according to embodiments of the present invention includes: a first probe including a coaxial line and having an opened end as a detection end; a second probe including a coaxial line and having an opened end as a detection end, the second probe having a longer penetration length than the first probe; and a measurement instrument configured to determine, from a result of a measurement of a measurement object using the first probe and a result of a measurement of the measurement object using the second probe, a permittivity of a second medium of the measurement object in which a first medium on an outer-layer side that is thinner than a penetration length of the first probe and the second medium on a deep-layer side relative to the first medium are stacked on each other.

A dielectric spectroscopic measurement method according to embodiments of the present invention of determining, by a dielectric spectroscopy method using a first probe including a coaxial line and having an opened end as a detection end and a second probe including a coaxial line and having an opened end as a detection end, the second probe having a longer penetration length than the first probe, a permittivity εₛ of a second medium of a measurement object in which a first medium on an outer-layer side that is thinner than a penetration length of the first probe and the second medium on a deep-layer side relative to the first medium are stacked on each other, the dielectric spectroscopic measurement method includes: a first step of determining an actual measured value of permittivity of the first medium by a measurement of the measurement object using the first probe and determining an actual measured value Y_{measured} of admittance at the detection end of the second probe by a measurement of the measurement object using the second probe; a second step of determining, with use of a model of admittance at the detection end of the second probe with a permittivity ε₁ of the first medium and the permittivity εₛ, a model value Y_{model} of admittance at the detection end of the second probe with an assumption that the permittivity ε₁ is defined as the actual measured value of permittivity and the permittivity εₛ is defined as a variable; and a third step of determining the permittivity εₛ at which the actual measured value Y_{measured} and the model value Y_{model} become equal.

### Effects of Embodiments of the Invention

As described hereinbefore, according to embodiments of the present invention, the use of the first probe and the second probe, which has a longer penetration length than the first probe, enables a multilayer measurement target to be accurately measured by a dielectric spectroscopy method using a coaxial probe.

### BRIEF DESCRIPTION OF THE DRAWINGS

FIG. 1 is a configuration diagram illustrating a configuration of a dielectric spectroscopic measurement apparatus according to an embodiment of the present invention.

FIG. 2A is a side view illustrating a partial configuration of another dielectric spectroscopic measurement apparatus according to an embodiment of the present invention.

FIG. 2B is a bottom view illustrating a partial configuration of another dielectric spectroscopic measurement apparatus according to an embodiment of the present invention.

FIG. 3 is a characteristic diagram illustrating a decay rate of an electric field strength of each probe in a direction toward a measurement object.

FIG. 4 is a diagram of assistance in explaining a model configuration of the measurement object.

FIG. 5 is a flowchart for explaining a dielectric spectroscopic measurement method according to an embodiment of the present invention.

FIG. 6 is a characteristic diagram illustrating a result of a measurement by the dielectric spectroscopic measurement method according to an embodiment of the present invention.

### DETAILED DESCRIPTION OF ILLUSTRATIVE EMBODIMENTS

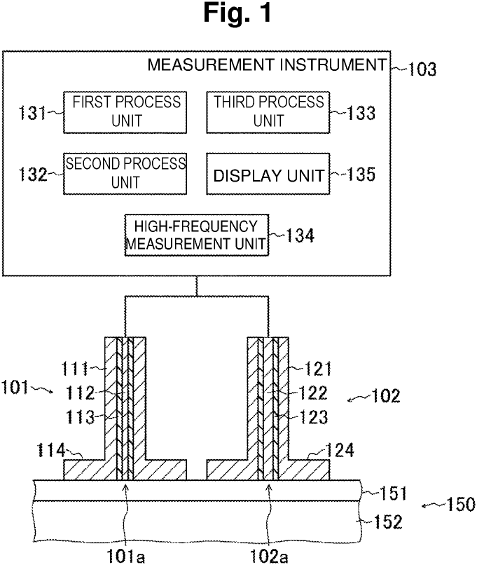

Description will be made below on a dielectric spectroscopic measurement apparatus according to an embodiment of the present invention with reference to FIG. 1. The dielectric spectroscopic measurement apparatus includes a first probe 101, a second probe 102, and a measurement instrument 103.

The first probe 101 includes a coaxial line and has an opened end as a detection end 101a. The second probe 102 includes a coaxial line and has an opened end as a detection end 102a. Further, the second probe 102 has a longer penetration length than the first probe 101. With use of these probes, a permittivity of a measurement object 150 is to be measured as an electrical signal.

The measurement instrument 103 determines, from a result of a measurement of the measurement object using the first probe 101 and a result of a measurement of the measurement object using the second probe 102, a permittivity of a second medium 152 of the measurement object 150 in which a first medium 151 on an outer-layer side that is thinner than the penetration length of the first probe 101 and the second medium 152 on a deep-layer side relative to the first medium 151 are stacked on each other.

The first probe 101 includes the coaxial line including an outer conductor 111 and an inner conductor 112 with a space between the outer conductor 111 and the inner conductor 112 filled with a dielectric layer 113 including a fluorine resin or the like. Electrical properties such as impedance and admittance of the measurement object 150 can be measured by the first probe 101 with use of a leakage electromagnetic field occurring between the outer conductor 111 and the inner conductor 112, which are brought into contact with the measurement object 150 at the detection end 101a.

Further, the detection end 102a of the first probe 101 can be provided with, for example, a fringe 114. The disc-shaped fringe 114 can be provided at an end portion of the columnar first probe 101. The fringe 114 is provided on the outer conductor 111. A surface of the fringe 114 in a direction perpendicular to a waveguide direction of the coaxial line is, for example, wider than a region where the electric field strength of the leakage electric field from the detection end 101a becomes 1% or less of a maximum value.

The second probe 102 includes the coaxial line including an outer conductor 121 and an inner conductor 122 with a space between the outer conductor 121 and the inner conductor 122 filled with a dielectric layer 123 including a fluorine resin or the like. An outer diameter of the inner conductor 122 is larger than an outer diameter of the inner conductor 112. Electrical properties such as impedance and admittance of the measurement object 150 can be measured by the second probe 102 with use of a leakage electromagnetic field occurring between the outer conductor 121 and the inner conductor 122, which are in contact with the measurement object 150 at the detection end 102a.

Further, the detection end 102a of the second probe 102 can be provided with, for example, a fringe 124. The disc-shaped fringe 124 can be provided at an end portion of the columnar second probe 102. The fringe 124 is provided on the outer conductor 121. A surface of the fringe 124 in a direction perpendicular to a waveguide direction of the coaxial line is, for example, wider than a region where the electric field strength of the leakage electric field from the detection end 102a becomes 1% or less of a maximum value.

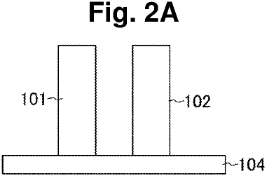

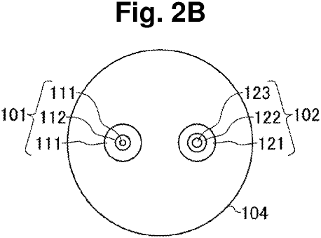

Further, as illustrated in FIG. 2A and FIG. 2B, the first probe 101 and the second probe 102 can be integrated in a common fringe 104. By virtue of such integration of the first probe 101 and the second probe 102 in the common fringe 104, measurement regions (the detection end 101a, the detection end 102a) of both can be brought close to each other. Such a configuration makes it possible to measure a heterogeneous material, a material with a narrow measurement region, or the like.

The measurement instrument 103 includes a first process unit 131, a second process unit 132, a third process unit 133, a high-frequency measurement unit 134, and a display unit 135. The high-frequency measurement unit 134 sweeps a frequency within a predetermined range to generate an electromagnetic wave and supplies the electromagnetic wave to the first probe 101 and the second probe 102. In addition, with the electromagnetic wave absorbed in the measurement object 150 at each of the first probe 101 and the second probe 102, the high-frequency measurement unit 134 measures (observes) an amplitude and a phase of the electromagnetic wave.

It should be noted that the high-frequency measurement unit 134 is, for example, a vector network analyzer. Alternatively, a commercially available impedance analyzer, LCR meter, or the like is usable as the high-frequency measurement unit 134.

The first process unit 131 first determines an actual measured value of permittivity of the first medium 151 from a measurement result measured by the high-frequency measurement unit 134 through the measurement of the measurement object 150 using the first probe 101. The first process unit 131 also determines an actual measured value Y_{measured} of admittance at the detection end 102a of the second probe 102 from a measurement result measured by the high-frequency measurement unit 134 through the measurement of the measurement object 150 using the second probe 102.

With use of a model of admittance at the detection end 102a of the second probe 102 with a permittivity ε₁ of the first medium 151 and a permittivity εₛ of the second medium 152, the second process unit 132 determines a model value Y_{model} of admittance at the detection end 102a of the second probe 102 with an assumption that the permittivity ε₁ is the actual measured value of permittivity and the permittivity εₛ is a variable.

The third process unit 133 determines the permittivity εₛ at which the actual measured value Y_{measured} and the model value Y_{model} become equal. The display unit 135 displays a result determined by the third process unit 133.

Next, the dielectric spectroscopic measurement apparatus according to the embodiment will be described in more detail.

A characteristic impedance of the coaxial line is represented by Expression (1) below. In Expression (1), Zo is a characteristic impedance (Ω) of the coaxial line, εᵣ is a parameter indicating a relative permittivity of a dielectric layer in the coaxial line, a is a radius of an outer diameter of an inner conductor, and b is a radius of an inner diameter of an outer conductor. Further, a cutoff frequency of the coaxial line is represented by Expression (2) below. In Expression (2), fc is the cutoff frequency and v is the speed of light. Expressions (1) and (2):

$$\text{Z0 =} \frac{138.061}{\sqrt{{ε}_{r}}} log \frac{b}{a}$$

$$\text{fc =} \frac{v}{π \sqrt{{ε}_{r}} \left(a + b\right)}$$

For example, the high-frequency measurement unit in the measurement instrument 103 is typically designed such that the characteristic impedance becomes 50 Ω or 75 Ω. Accordingly, the parameters a, b, and εᵣ are designed such that an upper limit of a measurement frequency does not become the cutoff frequency fc or less and the characteristic impedance satisfies the above. For example, in a case where the upper limit of the measurement frequency is 50 GHz, the characteristic impedance is 50 Ω, and the dielectric layer between the outer conductor and the inner conductor is a fluorine resin (εᵣ ≈ 2.2), a is 0.175 mm, and b is 0.8 mm.

While the characteristic impedances of the first probe 101 and the second probe 102 are designed to be the same in value, the outer diameter of the inner conductor 122 is designed to be larger than the outer diameter of the inner conductor 112. It means that the first probe 101 and the second probe 102 have a structure that satisfies Expression (3). It should be noted that in Expression (3), numbers of the variables denote the first probe 101 and the second probe 102. Expression (1):

$$\left\{\begin{matrix}{a}_{1} & \neq & {a}_{2} \\ {b}_{1} & \neq & {b}_{2} \\ \underline{{b}_{1}} & ≅ & \underline{{b}_{2}} \\ {a}_{1} & & {a}_{2}\end{matrix}\right)$$

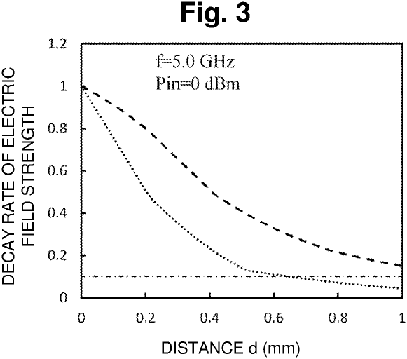

For example, in a case where the upper limit of the measurement frequency is 50 GHz, the characteristic impedance is 50 Ω, and the material of the dielectric layer is a fluorine resin (εᵣ ≈ 2.2), a₁, b₁, a₂, and b₂ are 0.175 mm, 0.8 mm, 0.33 mm, and 1.5 mm, respectively. It should be noted that in the embodiment, a₁ < a₂ and b₁ < b₂. and the second probe 102 has a wide opening and is low in cutoff frequency. At this time, a decay rate of an electric field strength of each of the probes in a direction toward the measurement object 150 is as in FIG. 3. In FIG. 3, a dotted line represents characteristics of the first probe 101 and a dashed line represents characteristics of the second probe 102. As illustrated in FIG. 3, the second probe 102 penetrates deeper.

Here, the first process unit 131 calculates the permittivity of the measurement object 150 from impedance, admittance, reflection coefficient, etc. measured by the high-frequency measurement unit 134. For example, with use of a first reference substance, a second reference substance, and a third reference substance, permittivities of which are known in advance, the permittivity of the measurement object 150 is calculated by Expression (4) and Expression (5) below, or the like. Expressions (4) and (5):

$$\frac{\left({ρ}_{4} - {ρ}_{1}\right) \left({ρ}_{3} - {ρ}_{2}\right)}{\left({ρ}_{4} - {ρ}_{2}\right) \left({ρ}_{1} - {ρ}_{3}\right)} = \frac{\left({y}_{4} - {y}_{1}\right) \left({y}_{3} - {y}_{2}\right)}{\left({y}_{4} - {y}_{2}\right) \left({y}_{1} - {y}_{3}\right)}$$

$${y}_{i} = {ε}_{i} + \frac{{G}_{0}}{j ω {C}_{0}} {ε}_{i}^{5 / 2}$$

Here, ρ₁ is a reflection coefficient determined as a result of a measurement of the first reference substance, ρ₂ is a reflection coefficient determined as a result of a measurement of the second reference substance, and ρ₃ is a reflection coefficient determined as a result of a measurement of the third reference substance. Further, ρ₄ is a reflection coefficient determined as a result of a measurement of a target substance.

Further, y₁ is a linear mapping of admittance determined as a result of a measurement of the first reference substance having a permittivity of ε₁, y₂ is a linear mapping of admittance determined as a result of a measurement of the first reference substance having a permittivity of ε₂, and y₃ is a linear mapping of admittance determined as a result of a measurement of the first reference substance having a permittivity of ε₃. Further, y₄ is a linear mapping of admittance determined as a result of a measurement of the measurement object 150 having a permittivity of ε₄. Gₒ denotes a characteristic impedance of a portion of each of the probes projecting outside with respect to the detection end.

The permittivity of the measurement object 150 is calculated by using the first reference substance, the second reference substance, and the third reference substance, each of which has a known permittivity, as calibration standards. Air, solid, liquid metal, water, or an organic solvent such as alcohol is usable as the calibration standards.

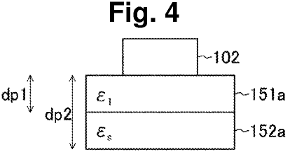

Here, the dielectric spectroscopic measurement apparatus (the second process unit 132) according to the embodiment provides an effective permittivity model for the object 150 as a material including a dielectric body 151a and a dielectric body 152a as illustrated in FIG. 4. Here, the effective permittivity is determinable by measurement. In FIG. 4, dp1 is a penetration depth of the first probe 101 and dp2 is a penetration depth of the second probe 102. The penetration depth refers to a distance required for the electric field strength in FIG. 3 to decay to a certain value, for example, any value in a range from 10% to 30%. ε₁ is an actual measured value determined by measurement using the first probe 101. Further, εₛ is a permittivity of the second medium 152 in FIG. 1. It should be noted that in a typical coaxial probe method, with respect to an effective permittivity of the measurement object 150, the measurement object 150 is assumed to be a dielectric body of a material that is uniform at the measured permittivity.

A model of admittance for measuring a two-layer medium including the above-described two types of dielectric bodies can be represented by, for example, Expression (6) below (see Reference Literature 1). Expression (6):

$$\begin{matrix}{Y}_{m o d e l} \left({ε}_{s}\right) = \frac{j {k}_{0} ε 1}{\sqrt{{ε}_{c}} I n \left(\frac{b}{a}\right)} \left\{{\int }_{0}^{∞} \frac{1}{{γ}_{p 1}}\right) \frac{{\left[{J}_{0} \left(ζ a\right) - {J}_{0} \left(ζ b\right)\right]}^{2}}{ζ} d ζ \\ + {\int }_{0}^{∞} \frac{1}{{γ}_{1}} \frac{2 \left({ε}_{s} {γ}_{1} - {ε}_{s} {γ}_{s}\right) {e}^{- 2 {γ}_{1} d {p}_{1}}}{\left({ε}_{s} {γ}_{1} + {ε}_{1} {γ}_{s}\right) - \left({ε}_{s} {γ}_{1} - {ε}_{1} {γ}_{s}\right) {e}^{- 2 {γ}_{1} d {p}_{1}}} \left(\frac{{\left[{J}_{0} \left(ζ a\right) - {J}_{0} \left(ζ b\right)\right]}^{2}}{ζ} d ζ\right\}\end{matrix}$$

In Expression (6), ε_{c} is a permittivity of an insulation body of the coaxial line, kₒ is a wave number of a measurement frequency, ε₁ and γ₁ are a permittivity and a propagation constant of the outer-layer-side dielectric body, εₛ and γₛ are a permittivity and a propagation constant of the deep-layer-side dielectric body, Jₒ(x) is a o-order Bessel function, and ζ is a variable with Hankel transform. Further, the penetration depth dp1 of the first probe 101 is designed to be larger than a thickness of the first medium 151. This causes an influence of the permittivity and thickness of the outer layer, or first medium 151, to be encompassed in the permittivity ε₁ determined by measurement using the first probe 101, which makes it possible to treat the dielectric body 152a in the effective permittivity model illustrated in FIG. 4A as having the same permittivity as the second medium 152.

It should be noted that a model of admittance for measuring a two-layer medium including the above-described two types of dielectric bodies can also be represented by, for example, Expression (7) below (see Reference Literature 1). It should be noted that in Expression (7), M is a decay rate of a strength of the coaxial probe. Further, Expression (8) is used for an evaluation function. εₘₑₐₛ is a measured effective permittivity. Expressions (7) and (8):

$$\begin{matrix}{C}_{m o d e l} = {C}_{f} + {ε}_{1} {C}_{0} + \left({ε}_{s} - {ε}_{1}\right) {C}_{0} {e}^{\frac{{}^{\_ d p 1}}{M}} \\ {C}_{m o d e l} \text{-} {C}_{m e a s u r e d} = {C}_{f} + {ε}_{1} {C}_{0} + \left({ε}_{s}\right)\end{matrix}$$

$$\left(- {ε}_{1}\right) {C}_{0} {e}^{\frac{\_ d p 1}{M}} ∼ \left({C}_{f} + {ε}_{m e a s} {C}_{0}\right) = 0$$

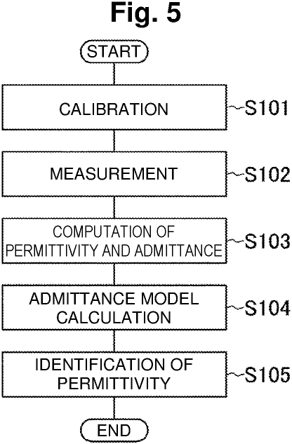

Next, description will be made on a dielectric spectroscopic measurement method according to an embodiment of the present invention with reference to FIG. 5. This measurement method is a method to determine the permittivity εₛ of the second medium 152 of a measurement object, in which the first medium 151 on the outer-layer side that is thinner than the penetration length of the first probe 101 and the second medium 152 on the deep-layer side relative to the first medium 151 are stacked on each other, by a dielectric spectroscopic method using the first probe 101 and the second probe 102.

First, in Step S101, a measurement surface, or outer surface, of the measurement object 150 (the first medium 151) is subjected to calibration so that the outer surface serves as a boundary surface between the probe and the measurement target. As a material having a known permittivity, air, metal, or pure water is used as a standard sample, thereby obtaining data for calibration. In a case where metal is not used as the standard sample, two types of organic solvents such as alcohol may be used instead.

Next, in Step S102, measurement using the first probe 101 and measurement using the second probe 102 are performed.

Next, in Step S103, the first process unit 131 determines the actual measured value of permittivity of the first medium 151 from a measurement result measured by the high-frequency measurement unit 134 through the measurement of the measurement object 150 using the first probe 101. Further, the first process unit 131 determines the actual measured value Y_{measured} of admittance at the detection end 102a of the second probe 102 from a measurement result measured by the high-frequency measurement unit 134 through the measurement of the measurement object 150 using the second probe 102 (a first step).

Next, in Step S104, with use of a model of admittance at the detection end 102a of the second probe 102 with a permittivity ε₁ of the first medium 151 and a permittivity εₛ of the second medium 152, the second process unit 132 determines a model value Y_{model} of admittance at the detection end 102a of the second probe 102 with an assumption that the permittivity ε₁ is the actual measured value of permittivity and the permittivity εₛ is a variable (a second step). The model of admittance can be a model represented by, for example, Expression (6).

Next, in Step S105, the permittivity εₛ of the second medium 152 is determined by an inverse problem analysis where the actual measured value Y_{measured} and the model value Y_{model} become equal (a third step).

A dielectric spectroscopic spectrum can be obtained by repeatedly performing the above-described Step S101 to Step S105 for a number of times corresponding to predetermined frequency points.

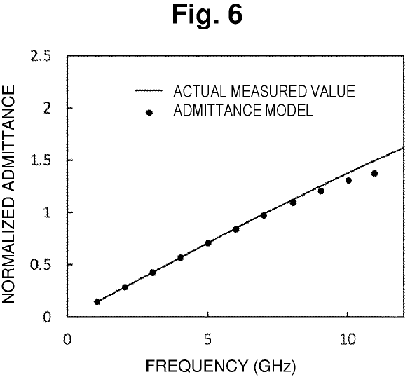

FIG. 6 illustrates a result of an actual measurement by the above-described measurement method. The measurement object 150 includes a polyethylene sheet as the first medium 151 and normal saline as the second medium 152. In FIG. 5, a solid line represents the actual measured value Y_{measured} determined by the actual measurement and a dotted line represents the model value Y_{model} determined with Expression (6) as a model. It is demonstrated that the admittance at the detection end 102a of the second probe 102 is successfully expressed with accuracy by the model value Y_{model} with Expression (6) as the model.

It should be noted that a measurement instrument in a dielectric spectroscopic measurement apparatus according to the above-described embodiment may be provided by computer equipment including a CPU (Central Processing Unit), a main storage, an external storage, a network connection apparatus, etc. so that the CPU is caused to work in accordance with a program developed in the main storage (run the program), thereby implementing the above-described functions (the dielectric spectroscopic measurement method). The above-described program is a program for a computer to perform the dielectric spectroscopic measurement method described in the above-described embodiment. Further, the functions may be distributed among a plurality of pieces of computer equipment.

Further, the measurement instrument in the dielectric spectroscopic measurement apparatus according to the above-described embodiment may include a programmable logic device (PLD) such as an FPGA (field-programmable gate array). For example, logic elements of the FPGA may be provided with a first process unit, a second process unit, a third process unit, and a fourth process unit as individual circuits, thereby being able to function as a measurement instrument. The first process unit, the second process unit, the third process unit, and the fourth process unit can each be written in the FPGA with a predetermined writing apparatus connected. Further, the writing apparatus connected to the FPGA enables the above-described circuits written in the FPGA to be seen.

As described hereinbefore, according to embodiments of the present invention, the use of the first probe and the second probe, which has a longer penetration length than the first probe, enables a multilayer measurement target to be accurately measured by a dielectric spectroscopy method using a coaxial probe.

It should be noted that embodiments of the present invention are not limited to the exemplary embodiments described hereinbefore and it is obvious that a lot of modifications and combinations are achievable by a person having ordinary skill in the art within the technical scope of the present invention.

Reference Literature 1: Kok Yeow You, “RF Coaxial Slot Radiators: Modeling, Measurements, and Applications”, ISBN: 9781608078226.

Reference Signs List

| | |
|---|---|
| 101 | First probe |
| 101 a | Detection end |
| 102 | Second probe |
| 102 a | Detection end |
| 103 | Measurement Instrement |
| 111 | Outer conductor |
| 112 | Inner conductor |
| 113 | Dielectric layer |
| 114 | Fringe |
| 121 | Outer conductor |
| 122 | Inner conductor |
| 123 | Dielectric layer |
| 124 | Fringe |
| 131 | First process unit |
| 132 | Second process unit |
| 133 | Third process unit |
| 134 | High-frequency measurement unit |
| 135 | Display unit |
| 150 | Measurement object |
| 151 | First medium |
| 152 | Second medium |

1-7. (canceled)

8. A dielectric spectroscopic measurement apparatus comprising:
a first probe comprising a first coaxial line and having a first opened end as a first detection end;
a second probe comprising a second coaxial line and having a first opened end as a second detection end, the second probe having a longer penetration length than the first probe; and
a measurement instrument configured to determine, from a result of a first measurement of a measurement object using the first probe and a result of a second measurement of the measurement object using the second probe, a permittivity of a second medium of the measurement object;
wherein a first medium and the second medium are stacked on each other;
wherein the first medium is on an outer-layer side and is thinner than a penetration length of the first probe; and
wherein the second medium is on a deep-layer side relative to the first medium.

9. The dielectric spectroscopic measurement apparatus according to claim 8, wherein the first probe and the second probe are each provided with a fringe at the first detection end and the second detection end, respectively.

10. The dielectric spectroscopic measurement apparatus according to claim 9, wherein a surface of the respective fringe in a direction perpendicular to a waveguide direction of the first coaxial line or the second coaxial line is wider than a region where an electric field strength of a leakage electric field from the first detection end or the second detection end becomes 1% or less of a maximum value.

11. The dielectric spectroscopic measurement apparatus according to claim 8, wherein the first probe and the second probe are provided with a common fringe at the first detection end and the second detection end.

12. The dielectric spectroscopic measurement apparatus according to claim 8, wherein the measurement instrument comprises:
a first processor configured to:
determine an actual measured value of permittivity of the first medium by the first measurement of the measurement object using the first probe, in which the first medium on the outer-layer side that is thinner than the penetration length of the first probe and the second medium on the deep-layer side relative to the first medium are stacked on each other; and
determine an actual measured value of admittance at the second detection end of the second probe by the second measurement of the measurement object using the second probe;
a second processor configured to:
determine, with use of a model of admittance at the second detection end of the second probe with a first permittivity of the first medium and a second permittivity of the second medium, a model value of admittance at the second detection end of the second probe with an assumption that the first permittivity is the actual measured value of permittivity and the second permittivity is a variable; and
a third processor configured to determine the second permittivity at which the actual measured value and the model value become equal.

13. The dielectric spectroscopic measurement apparatus according to claim 12, wherein the second processor is configured to use an admittance model represented by the following expression:
$${}_{{γ}_{\text{mode}} \left({ε}_{2}\right) = \frac{j {k}_{o} {ε}_{1}}{\sqrt{{ε}_{c}} l n \left(\frac{b}{a}\right)} \left\{{\int }_{\text{o}}^{∞} \frac{1}{{γ}_{p 1}}\right) \frac{{\left[{j}_{o} \left(ς α\right) - j o \left(ς b\right)\right]}^{2}}{ς} d ς}$$
$$+ {\int }_{0}^{∞} \frac{1}{{γ}_{1}} \frac{2 \left({ε}_{s} {γ}_{3} - {ε}_{1} {γ}_{3}\right) {e}^{- 2 {y}_{1} d p 1}}{\left({ε}_{s} {γ}_{1} + {ε}_{1} {γ}_{s}\right) - \left({ε}_{s} {γ}_{3} - {ε}_{1} {γ}_{3}\right) {e}^{- 2 {y}_{1} d p 1}} \left(\frac{{\left[{J}_{0} \left(ς α\right) - {J}_{0} \left(ς b\right)\right]}^{2}}{ς} d ς\right\} ,$$
wherein ε_{c} is a permittivity of an insulation body of the first coaxial line or the second coaxial line, kₒ is a wave number of a measurement frequency, ε₁and γ₁ are a permittivity and a propagation constant of the first medium, εₛ and γₛ are a permittivity and a propagation constant of the second medium, Jₒ(x) is a o-order Bessel function, ζ is a variable with Hankel transform, and dp1 is a penetration depth of the first probe.

14. The dielectric spectroscopic measurement apparatus according to claim 12, further comprising a display configured to display a result determined by the third processor.

15. The dielectric spectroscopic measurement apparatus according to claim 8, wherein the measurement instrument comprises a high-frequency measurement device configured to measure an amplitude and a phase of an electromagnetic wave.

16. A dielectric spectroscopic measurement method comprising:
determining, by a dielectric spectroscopy method using a first probe comprising a first coaxial line and having a first opened end as a first detection end and a second probe comprising a second coaxial line and having a first opened end as a second detection end, the second probe having a longer penetration length than the first probe, a second permittivity of a second medium of a measurement object in which a first medium on an outer-layer side that is thinner than a penetration length of the first probe and the second medium on a deep-layer side relative to the first medium are stacked on each other;
determining an actual measured value of permittivity of the first medium by a first measurement of the measurement object using the first probe;
determining an actual measured value of admittance at the second detection end of the second probe by a second measurement of the measurement object using the second probe;
determining, with use of a model of admittance at the second detection end of the second probe with a first permittivity of the first medium and the second permittivity of the second medium, a model value of admittance at the second detection end of the second probe with an assumption that the first permittivity is the actual measured value of permittivity and the second permittivity is a variable; and
determining the second permittivity at which the actual measured value and the model value become equal.

17. The dielectric spectroscopic measurement method according to claim 16, wherein determining the model value of admittance comprises using an admittance model represented by the following expression:
$${Y}_{m o d e} \left({ε}_{s}\right) = \frac{j {k}_{0} {ε}_{1}}{\sqrt{{ε}_{c}} l n \left(\frac{b}{a}\right)} \left\{{\int }_{0}^{∞} \frac{1}{{V}_{p 1}} \frac{{\left[{J}_{0} \left(ς a\right) - {J}_{0} \left(ς b\right)\right]}^{2}}{ς} d ς\right)$$
$$+ {\int }_{0}^{∞} \frac{1}{{γ}_{1}} \frac{2 \left({ε}_{s} {γ}_{1} - {ε}_{1} {γ}_{s}\right) {e}^{- 2 {y}_{1} d p 1}}{\left({ε}_{s} {γ}_{1} + {ε}_{1} {γ}_{s}\right) - \left({ε}_{s} {γ}_{3} - {ε}_{1} {γ}_{3}\right) {e}^{- 2 {γ}_{1} d p 1}} \left(\frac{{\left[{J}_{0} \left(ς a\right) - {J}_{0} \left(ς b\right)\right]}^{2}}{ς} d ς\right\} ,$$
wherein ε_{c}, is a permittivity of an insulation body of the first coaxial line or the second coaxial line, kₒ is a wave number of a measurement frequency, ε₁ and γ₁ are a permittivity and a propagation constant of the first medium, εₛ and γₛ are a permittivity and a propagation constant of the second medium, Jₒ(x) is a o-order Bessel function, ζ is a variable with Hankel transform, and dp1 is a penetration depth of the first probe.

18. The dielectric spectroscopic measurement method according to claim 16, wherein the first probe and the second probe are each provided with a fringe at the first detection end and the second detection end, respectively.

19. The dielectric spectroscopic measurement method according to claim 18, wherein a surface of the respective fringe in a direction perpendicular to a waveguide direction of the first coaxial line or the second coaxial line is wider than a region where an electric field strength of a leakage electric field from the first detection end or the second detection end becomes 1% or less of a maximum value.

20. The dielectric spectroscopic measurement method according to claim 16, wherein the first probe and the second probe are provided with a common fringe at the first detection end and the second detection end.
